(19) United States
(12) Patent Application Publication
(10) Pub. No.: US 2013/0110485 A1
(43) Pub. Date: May 2, 2013

(54) Determining Interwell Communication

(71) Applicants: Weichang Li, Annandale, NJ (US); Niranjan A. Subrahmanya, Bridgewater, NJ (US); Limin Song, West Windsor, NJ (US); Adam K. Usadi, Basking Ridge, NJ (US); Krishnan Kumaran, Raritan, NJ (US); Peng Xu, Annandale, NJ (US); Michael E. McCracken, Flower Mound, TX (US); Dale E. Fitz, Houston, TX (US)

(72) Inventors: Weichang Li, Annandale, NJ (US); Niranjan A. Subrahmanya, Bridgewater, NJ (US); Limin Song, West Windsor, NJ (US); Adam K. Usadi, Basking Ridge, NJ (US); Krishnan Kumaran, Raritan, NJ (US); Peng Xu, Annandale, NJ (US); Michael E. McCracken, Flower Mound, TX (US); Dale E. Fitz, Houston, TX (US)

(21) Appl. No.: 13/646,363

(22) Filed: Oct. 5, 2012

Related U.S. Application Data
(60) Provisional application No. 61/551,688, filed on Oct. 26, 2011.

(51) Int. Cl. G06G 7/48

(52) U.S. Cl. 703/10

(57) ABSTRACT

There is provided a system and method for determining interwell communication in a hydrocarbon-producing field that has a plurality of wells. An exemplary method comprises determining communication relationships for the plurality of wells using a multivariate dynamic joint analysis algorithm based on data representing properties of each of the plurality of wells. The multivariate dynamic joint analysis algorithm may employ a self-response of each of the plurality of wells and an interwell response between combinations of the plurality of wells. Data representative of the communication relationships is provided.

### CROSS-REFERENCE TO RELATED APPLICATION

This application claims the priority benefit of U.S. Provisional Patent Application 61/551,688 filed Oct. 26, 2011 entitled DETERMINING INTERWELL COMMUNICATION, the entirety of which is incorporated by reference herein.

### FIELD

The present techniques relate to subsurface reservoir simulation, including providing three-dimensional (3D) data and/or visualizations of data corresponding to physical objects and analysis thereof. In particular, an exemplary embodiment of the present techniques relates to a method of determining interwell communication in a reservoir having multiple wells for the purpose of reservoir performance prediction.

### BACKGROUND

This section is intended to introduce various aspects of the art, which may be associated with embodiments of the disclosed techniques. This discussion is believed to assist in providing a framework to facilitate a better understanding of particular aspects of the disclosed techniques. Accordingly, it should be understood that this section is to be read in this light, and not necessarily as admissions of prior art.

Hydrocarbon exploration and production depend increasingly on developing three-dimensional (3D) models and simulations of subsurface regions. The ability to quantitatively establish reservoir characteristics, predict reservoir performance, understand connectivity, diagnose formation damage, and estimate fluid contact movement is an important aspect of operational decision-making in both reservoir appraisal and production phases. Some typical reservoir management decisions include where to locate injectors and producers and establishing operating conditions such as injection and production rates.

One frequently used technique for reservoir characterization is well testing, commonly referred to as pressure transient analysis. This approach often involves measuring bottomhole pressures during periods in which a well is shut-in. After measurement, production may be resumed. Well testing provides information about performance-critical variables such as average permeability, compressibility, skin factors, interwell connectivity, the presence of boundaries and faults and their locations and geometries, to name just a few examples.

Another common approach for reservoir and well performance prediction is reservoir simulation, in which reservoir parameters (some of which are mentioned herein) are adjusted so that the simulation models are calibrated against measured data such as pressure and production rate history. This is often referred to as history matching. The well behavior as quantified by these parameters, either with or without external data such as core/log measurements, can be used to characterize formation, identify interwell connectivity, characterize communication and/or potential damages.

The information source for these processing tasks consists of various wellbore sensor measurements such as downhole pressures, flow rates and temperatures. Recent advances in permanent monitoring have enabled the collection of high frequency well data including surface and downhole pressures, temperatures, and rates. Taking these measurements as input, signal processing/machine learning algorithms may be useful in estimating the values or extracting the trends of parameters critical to reservoir performance.

Pressure transient analysis employs pressure and flow rate data collected when the production at one or several wells is shut-in and then opened up for production over a certain period and possibly repeated over time. One common practice is to estimate certain pressure derivatives (with respect to the elapsed time or its natural log) in response to unit flow rate change. With further interpretation, the estimated derivative can then be used for reservoir diagnosis and regime verification by matching it against certain interpretation models. Applying robust deconvolution algorithms has been reported to produce reasonable results from field data. However, this type of analysis has been largely limited to single-well cases.

Despite the progress in single-well analysis, effort in multiwell analysis has so far remained largely unsuccessful. Multiwell generalization of single-well deconvolution approaches have shown to be very sensitive to both data quality and noise effects, caused by model over-parameterization (i.e., inclusion of too many parameters that may or may not significantly influence the response at a specific well) associated with the increased number of well pairs. Reducing multiwell communications into pairwise analysis is one known way to reduce the complexity. However, that strategy risks the possibility of highly inaccurate estimates by ignoring effects from other interfering wells (i.e., multi-parameter coupled influences). Other known approaches such as capacitance models, semianalytic models and correlation based approaches have also been reported with little success on field data. Furthermore, most of the reported work on these approaches requires data obtained from injection-production scenarios that may be difficult to employ in a practical sense (e.g., extended shut-in periods for multiple wells).

Interwell interference is a major complication in going from single-well analysis to analysis of multiple wells. Consider a reservoir field with multiple wells. First, pairwise analysis (such as correlation based or injection-production well pair based approaches) does not consider interference from wells other than the considered pair. The resulting response estimate can be contaminated by the effects from other wells in the field.

Second, interwell interference signals, e.g. the pressure fluctuations at one well caused by production changes at another well, typically have much longer bulk delay and delay spread than those induced by local well shut-in effects. Also, wells that are farther away have a weaker influence due to the diffusive nature of the pressure transients. These differences result from the fact that distance between wells is typically longer than the effective wellbore radius at an individual well. Also, fluid flow, and hence diffusion effects, may propagate from one well to another via multiple possible paths, further spreading out the response over a longer delay span. Without knowing the bulk delay in advance, the number of nominal parameters needed to capture the interwell response is proportional to the propagation delay. As a result, straightforward generalization of a convolution model to interwell communications is prone to the problem of over-parameterization.

Furthermore, the total number of unknown parameters is proportional to the number of interwell responses and can be significantly larger than that in the single well case. On the other hand, only a small subset of these nominal parameters is associated with the nonzero portion of the response pulses. Algorithms simply borrowed from single-well analysis may be blind to these structural issues and may be very sensitive to data uncertainty or noise, which severely limits their value in practice.

Finally, a long interwell spacing generally leads to a distinctly different connectivity response than the pressure-to-rate response locally at a single well. This suggests the need for a different modeling strategy for each type of process.

European (EP) Patent Application Publication No. EP1,701,001 by Gurpinar, et al., relates to a method of managing a fluid or a gas reservoir. In the disclosed method, diverse data having different acquisition time scales and spatial scales of coverage is assimilated for iteratively producing a reservoir development plan. The reservoir development plan is used for optimizing an overall performance of a reservoir.

U.S. Patent Application Publication No. 20030015319 by Green, et al., relates to a method and apparatus for acoustically actuating wellbore tools. The disclosed method and system employ two-way acoustic communication.

### SUMMARY

An exemplary embodiment of the present techniques relates to determining interwell communication in a hydrocarbon-producing field that has a plurality of wells. An exemplary method comprises determining communication relationships for the plurality of wells using a multivariate dynamic joint analysis algorithm based on data representing properties of each of the plurality of wells. The multivariate dynamic joint analysis algorithm may employ a self-response of each of the plurality of wells and an interwell response between combinations of the plurality of wells. Data representative of the communication relationships is provided.

An exemplary computer system according to the present techniques determines interwell communication in a hydrocarbon-producing field that has a plurality of wells. The computer system comprises a processor and a non-transitory, computer-readable storage medium that stores computer-readable instructions for execution by the processor. Computer-readable instructions stored on the storage media include code that, when executed by the processor, causes the processor to communication relationships for the plurality of wells using a multivariate dynamic joint analysis algorithm based on data representing properties of each of the plurality of wells. The multivariate dynamic joint analysis algorithm employs a self-response of each of the plurality of wells and an interwell response between combinations of the plurality of wells. Also stored on the storage media is code that, when executed by the processor, causes the processor to provide data representative of the communication relationships.

The present techniques also relate to methods for producing hydrocarbons using a determination of interwell communication in an oil and/or gas field that has a plurality of wells. The exemplary method of hydrocarbon production comprises determining communication relationships for a plurality of wells in the oil and/or gas field. The communication relationships are determined using a multivariate dynamic joint analysis algorithm based on data representing properties of each of the plurality of wells. The multivariate dynamic joint analysis algorithm employs a self-response of each of the plurality of wells and an interwell response between combinations of the plurality of wells. The method of hydrocarbon production also comprises providing data representative of the communication relationships. Hydrocarbons are extracted from the oil and/or gas field based on the data representative of the communication relationships. A visualization of the data representative of the communication relationships may be displayed to assist in the extraction of hydrocarbons.

### DESCRIPTION OF THE DRAWINGS

Advantages of the present techniques may become apparent upon reviewing the following detailed description and drawings of non-limiting examples of embodiments in which:

FIG. 1 is a graph showing a pressure drop response to an impulse change in the flow rate for a single well;

FIG. 2 is a graph showing a step response representing the pressure drop in response to constant production rate for a single well;

FIG. 3 is a diagram showing a multiwell reservoir model according to an exemplary embodiment of the present techniques;

FIG. 4 is a block diagram of a system for performing a reservoir analysis according to an exemplary embodiment of the present techniques;

FIG. 5, which includes FIGS. 5A and 5B, is a collection of panels showing an example of a synthetic three-well reservoir with homogeneous permeability, along with graphs showing simulation results therefor, according to an exemplary embodiment of the present techniques;

FIG. 6, which includes FIGS. 6A and 6B, is a collection of panels showing an example of a synthetic three-well reservoir with homogeneous permeability, and one barrier between two of the wells, along with graphs showing simulation results therefor, according to an exemplary embodiment of the present techniques;

FIG. 7, which includes FIGS. 7A and 7B, is a collection of panels showing an example of a synthetic three-well reservoir with homogeneous permeability, and one channel between two of the wells, along with graphs showing simulation results therefor, according to an exemplary embodiment of the present techniques;

FIG. 8 is a graph showing a comparison of impulse response estimates according to an exemplary embodiment of the present techniques;

FIG. 9 is a process flow diagram showing a method of performing an analysis of well communication according to an exemplary embodiment of the present techniques;

FIG. 10 is a process flow diagram showing a method for producing hydrocarbons from an oil and/or gas field according to an exemplary embodiment of the present techniques; and

FIG. 11 is a block diagram of a computer system that may be used to perform a method for summarizing data corresponding to a property of interest according to exemplary embodiments of the present techniques.

### DETAILED DESCRIPTION

In the following detailed description section, specific embodiments are described in connection with preferred embodiments. However, to the extent that the following description is specific to a particular embodiment or a particular use, this is intended to be for exemplary purposes only and simply provides a description of the exemplary embodiments. Accordingly, the present techniques are not limited to embodiments described herein, but rather, it includes all alternatives, modifications, and equivalents falling within the spirit and scope of the appended claims.

At the outset, and for ease of reference, certain terms used in this application and their meanings as used in this context are set forth. To the extent a term used herein is not defined below, it should be given the broadest definition persons in the pertinent art have given that term as reflected in at least one printed publication or issued patent.

As used herein, the term “computer component” refers to a computer-related entity, either hardware, firmware, software, a combination thereof, or software in execution. For example, a computer component can be, but is not limited to being, a process running on a processor, a processor, an object, an executable, a thread of execution, a program, and a computer. One or more computer components can reside within a process and/or thread of execution and a computer component can be localized on one computer and/or distributed between two or more computers.

As used herein, the terms “computer-readable storage medium”, “non-transitory, computer-readable storage medium” or the like refer to any tangible storage that participates in providing instructions to a processor for execution. Such a medium may take many forms, including but not limited to, non-volatile media, and volatile media. Non-volatile media includes, for example, NVRAM, or magnetic or optical disks. Volatile media includes dynamic memory, such as main memory. Computer-readable media may include, for example, a floppy disk, a flexible disk, hard disk, magnetic tape, or any other magnetic medium, magneto-optical medium, a CD-ROM, any other optical medium, a RAM, a PROM, and EPROM, a FLASH-EPROM, a solid state medium like a holographic memory, a memory card, or any other memory chip or cartridge, or any other physical medium from which a computer can read. When the computer-readable media is configured as a database, it is to be understood that the database may be any type of database, such as relational, hierarchical, object-oriented, and/or the like. Accordingly, exemplary embodiments of the present techniques may be considered to include a tangible, non-transitory storage medium or tangible distribution medium and prior art-recognized equivalents and successor media, in which the software implementations embodying the present techniques are stored.

As used herein, the term “connectivity” refers to a measure of the communication (or lack thereof) between points within a geologic zone. Connectivity is closely related to the reservoir internal geometry and is commonly a primary factor controlling hydrocarbon production efficiency and ultimate recovery.

As used herein, the term “de-noising algorithm” refers to a process performed on raw time series data of either pressure, temperature or flow rates, which are often very noisy, e.g., due to instrumentation noises or non-uniform sampling schemes (e.g. data drop out). Taking these data directly into learning algorithm will lead to performance degradation due to potential spurious effect caused by excessive level of noise. As a result, a signal de-noising algorithm may be applied as a pre-processing step.

As used herein, the term “face” refers to an arbitrary collection of points that form a surface.

As used herein, the term “fault” refers to a break in the earth layer and the adjacent horizon surfaces, across which there is observable displacement. A fault may either block the flow of hydrocarbons, creating a trap in which hydrocarbons may collect, or enhance the flow of hydrocarbons between regions in a reservoir.

As used herein, the term “fluid contact” refers to an interface between two different fluids, e.g., oil and water.

As used herein, the terms “injector” or “injection wells” refer to wells through which fluids are injected into a formation to enhance the production of hydrocarbons. The injected fluids may include, for example, water, steam, polymers, and hydrocarbons, among others.

As used herein, the term “interpretation algorithm” refers to a statistical model-based analysis that yields a representation of well connectivity in the forms of response functions and their characteristics. To derive the physical reservoir parameters such as permeability, porosity, and to interpret learning algorithm output in terms of these physical parameters, an analytical or heuristic physical model is associated with the statistical model.

As used herein, the term “model-based dynamic model learning algorithm” refers to a machine learning algorithms based on certain parametric dynamic models, instead of nonparametric or simple regression models. Given model structure, the algorithms learn the model parameters by mapping the data onto the model, so that certain error metrics are minimized.

As used herein, the term “multivariate dynamic joint analysis” refers to an analysis in which variables are formulated as a vector random process whose temporal-spatial dynamics are modeled in the form of multivariate state-space model. The analysis identifies the model parameters from measured data and then produces characteristic representations of the temporal-spatial dynamics, e.g. via response function or direct mapping of the physical parameters if governing equations are available.

As used herein, the terms “producers” or “production wells” refers to wells through which production fluids are removed from a reservoir.

As used herein, the term “property” refers to data representative of a characteristic associated with different topological elements on a per element basis. Generally, a property could be any computing value type, including integer and floating point number types or the like. Moreover, a property may comprise vectors of value types. Properties may only be valid for a subset of a geometry object's elements. Properties may be used to color an object's geometry. The term “property” may also refer to a characteristic or stored information related to an object. Application of the appropriate definition is intuitive to one skilled in the art of computer science.

As used herein, the terms “rapid scoping algorithm” and “segmentation algorithm” refer to algorithms that quickly segment data according to certain features, e.g. data segment associated with well shut in, production, normal behaving time period associated with these processes, or data manifesting abnormal responses to either shut-in or production. The outputs are suitable to be provided to the dynamic model learning algorithms for improved analysis.

As used herein, the term “self response” refers to the pressure drop response at a well associated with its own production.

As used herein, the term “skin factor” refers to an increase or decrease in the pressure drop due to extra flow resistance or flow enhancement near the wellbore, which can be predicted with Darcy's law using the value of permeability thickness, kh, determined from a buildup or drawdown test.

As used herein, the term “Superposition principle” refers to a scientific property of linear systems. Briefly stated the Superposition principle is that the net effect of multiple stimuli on a linear system is the sum of the individual effects of the stimuli.

As used herein, the terms “visualization engine” or “VE” refer to a computer component that is adapted to present a model and/or visualization of data that represents one or more physical objects.

As used herein, the term “well” refers to a surface location with a collection of wellbores. Wells may be visually rendered as a point or a glyph, along with a name.

As used herein, the term “wellbore” refers to a constituent underground path of a well and associated collections of path dependent data. A wellbore may be visually rendered as a collection of connected line segments or curves. Wellbores may also be visually rendered cylindrically with a radius.

Some portions of the detailed description which follows are presented in terms of procedures, steps, logic blocks, processing and other symbolic representations of operations on data bits within a computer memory. These descriptions and representations are the means used by those skilled in the data processing arts to most effectively convey the substance of their work to others skilled in the art. In the present application, a procedure, step, logic block, process, or the like, is conceived to be a self-consistent sequence of steps or instructions leading to a desired result. The steps are those requiring physical manipulations of physical quantities. These quantities may be stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions using the terms such as “adjusting”, “aligning”, “assigning”, “comparing”, “computing”, “creating”, “defining”, “determining”, “displaying”, “extracting”, “identifying”, “limiting”, “obtaining”, “performing”, “predicting”, “preparing”, “processing”, “producing”, “providing”, “representing”, “running”, “selecting”, “storing”, “summarizing”, “transforming”, “updating” or the like, refer to the action and processes of a computer system, or similar electronic computing device, that transforms data represented as physical (electronic) quantities within the computer system's registers and memories into other data similarly represented as physical quantities within the computer system memories or registers or other such information storage, transmission or display devices. Example methods may be better appreciated with reference to flow diagrams.

While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks. While the figures illustrate various serially occurring actions, it is to be appreciated that various actions could occur concurrently, substantially in parallel, and/or at substantially different points in time.

An exemplary embodiment of the present techniques relates to a statistical well-centric reservoir dynamic model and to the application of dynamic learning algorithms. Such algorithms address the dynamics of the production and shut-in processes, the sparse structures in the response function and the selective excitations associated with the testing at a particular well. The resulting algorithms provide a methodology even in the context of general signal processing or machine learning.

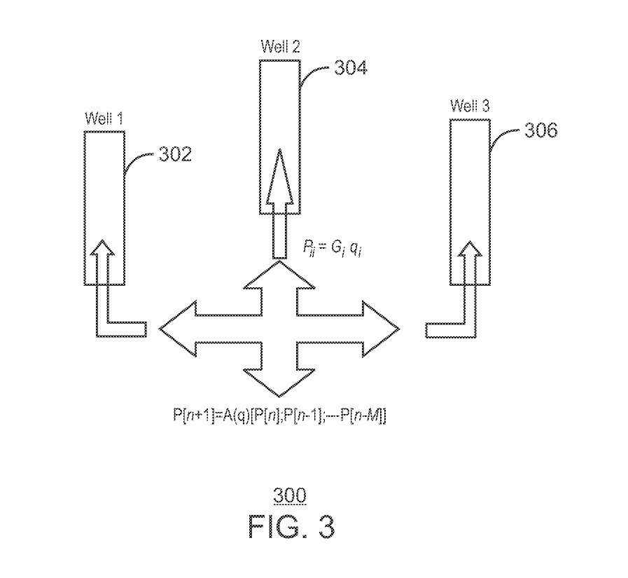

The present techniques provide an integrated workflow for joint multiwell analysis for the purpose of reservoir characterization, performance prediction and well event detection. Three related components are contemplated. The first component comprises a multivariate dynamic model structure that enables joint analysis of large numbers of wells and that captures both the self-response of local well production and interwell responses (see FIG. 3).

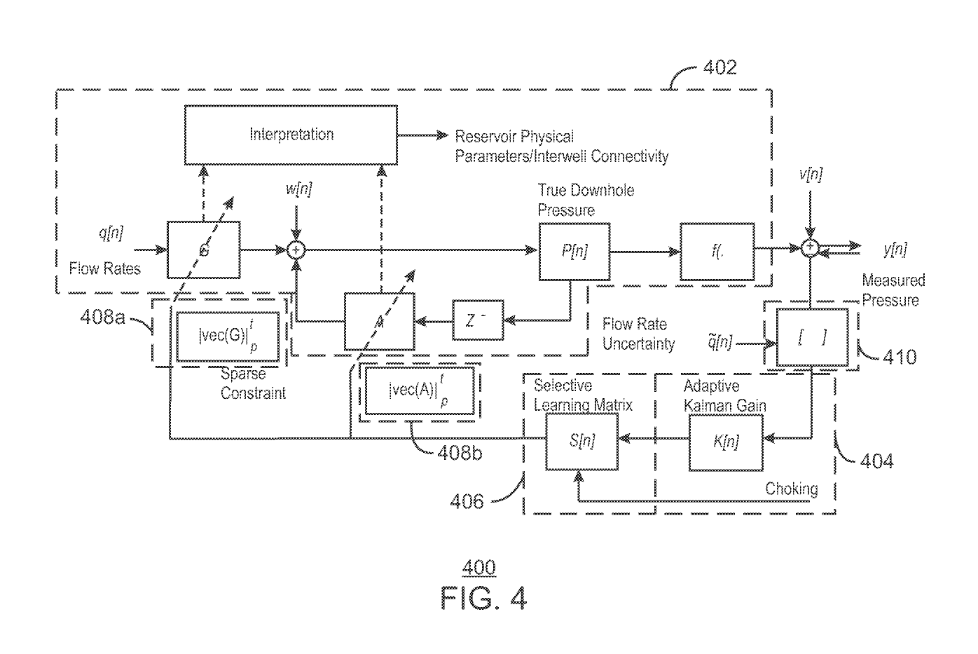

The second component comprises a set of model-based dynamic learning algorithms (as shown in FIG. 4) that sequentially analyze the measured reservoir pressure, rate and temperature data, and identify the model parameter values and trends. The model-based algorithms calculate a set of parameters including pressure rate responses/transfer functions for local as well as interwell dynamics. Additionally, the parameters may be divided into groups associated with testing and non-testing wells, respectively. The model-based algorithms adaptively adjust the learning pace for each group of wells.

The third component comprises a set of interpretation algorithms that map obtained response/transfer functions as well as any other estimated parameters into reservoir characteristic parameters such as skin factors, permeability, compressibility, interwell connectivity, boundaries, fault conditions and the like. The interpretation algorithms may be configured to extract trends of these parameters over time. The trend data can be used for assisted reservoir simulation history matching. These estimates and trends may then be provided as input data to a reservoir performance prediction process, production optimization or even further well testing planning. An interpretation model may combine external data such as the log/core measurements, seismic data and/or interpreted stratigraphic information, if available. In addition to these core components, a set of data pre-processing modules for data de-noising, rapid scoping and well event detection/data segmentation are contemplated. These processes may be performed before or in parallel with processes performed by the first and second components discussed herein.

### Single Well Model

An important law of fluid flow in porous media is Darcy's law. In a 1D horizontal linear system, it states that

$$v = \frac{q}{A} = - \frac{κ}{μ} \frac{d p}{d x} \qquad ( 1 )$$

where v, q, A are the velocity, volumetric flow rate and total cross-sectional area respectively. κ and μ are the rock permeability and fluid viscosity, and finally dp/dx is the pressure gradient along the same direction as v and q. Combined with the equation of mass conservation and the compressible fluid equation, Darcy's law leads to a diffusion equation that governs the pressure dynamics. For a source well in an infinite non-deformable formation, the pressure for a slightly compressible fluid is governed by the following diffusion equation:

$$\frac{\partial p}{\partial t} = ∇ \cdot D ∇ p \qquad ( 2 )$$

where D=κ/(φμc) is the diffusion time constant. Here, c is the fluid compressibility, and φ is the rock porosity.

Based on equation (2), the diffusive pressure field may be calculated for various reservoir configurations based on the appropriate initial condition, reservoir boundary condition and source condition (usually the flow rate induced pressure gradient at the wellbore boundary in the form of Darcy's law). When there is a flow rate change (e.g., because of shut-in), wellbore storage effect introduces two transient phenomena, namely pressure build-up (post shut-in) and drawdown (post production start-up). Additionally, the discrepancy between the well productivity in an ideal case and that in reality is generally accounted for by introducing the so-called skin factor. Both of these effects can be added onto the solution for the diffusion equation by imposing additional boundary conditions.

The linearity of both the Darcy's law and the diffusion equation allows one to apply the Superposition principle to greatly simplify the problem. More specifically, the pressure drop at a single well can be represented by a linear convolution between the time-varying flow rate and the rate-normalized pressure response:

Δp(t)=∫₀^{t}q(τ)Δp′ᵤ(t−τ)dτ=∫₀^{t}q(τ)q(t−τ)dτ (3)

which is called the Duhamel's principle. g(t−τ) is the step response representing the pressure drop in response to a constant production rate. In discrete time domain, the linear convolution form can be converted into a state-space model representation:

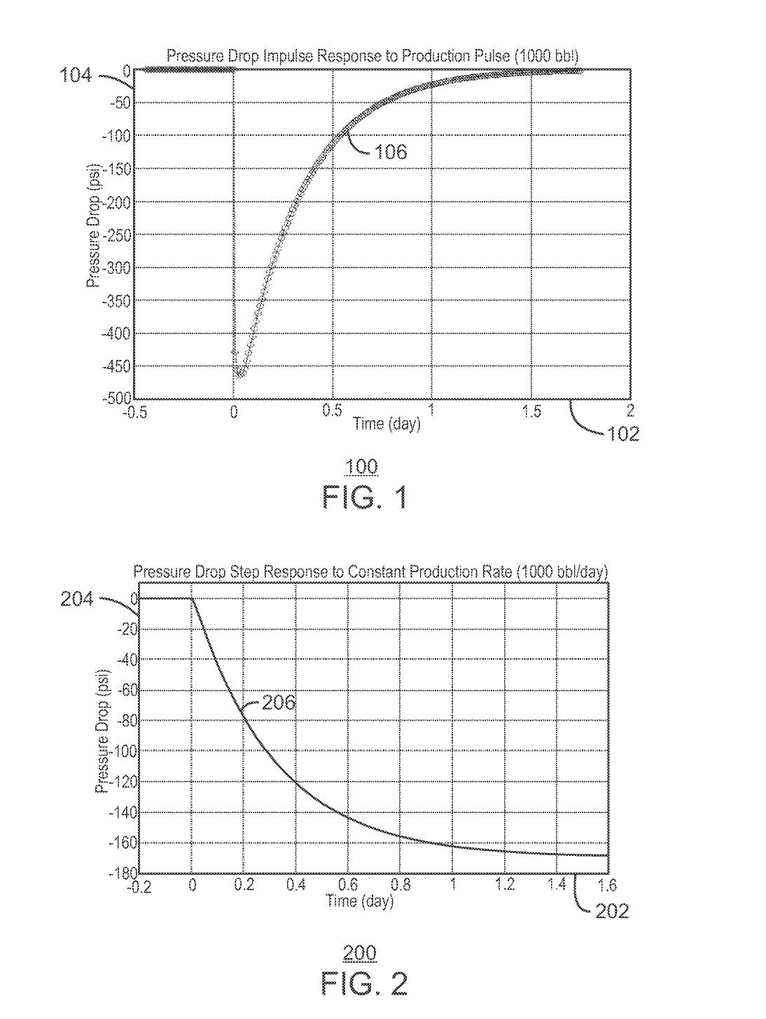

p[n]=p[n−1]+g^{t}[n−1]q[n]+w[n] (4)

where w[n] denotes noise; g=[\tilde{g}_{δt}(0), . . . , \tilde{g}_{δt}(Kδt)]^{t} is the delay-tapped response vector where \tilde{g}_{δt}(t−τ)=g(t−τ)−g(t−δt−τ) represents the impulse response, i.e., the pressure drop response to an impulse change in the flow rate. For an example single well, FIGS. 1 and 2 show the impulse response \tilde{g}_{δt}(t) and the step response g(t), respectively.

FIG. 1 is a graph 100 showing a pressure drop response to an impulse change in the flow rate for a single well. An x-axis 102 represents time in days and a y-axis 104 represents pressure in units of pounds per square inch (psi). A trace 106 shows an impulse response attributable to a production pulse of 1,000 barrels (bbl).

FIG. 2 is a graph 200 showing a step response representing the pressure drop in response to a constant production rate for a single well. An x-axis 202 represents time in days and a y-axis 204 represents pressure in units of pounds per square inch (psi). A trace 206 shows a step response attributable to a constant production rate of 1,000 barrels (bbl) per day.

### Joint Well Model

FIG. 3 is a diagram showing a multiwell model 300 according to an exemplary embodiment of the present techniques. The multiwell model 300 includes a first well 302, a second well 304 and a third well 306. As shown in FIG. 3, the Superposition principle is useful in predicting the effects of production and connection between the first well 302, the second well 304 and the third well 306. Moreover, the effects of production and interwell communications linearly superpose, according to the Superposition principle.

In a reservoir with multiple wells, the pressure-rate dynamics at each individual well and the communications among the wells are intertwined. For instance, the pressure increase in one well due to shut-in may raise the pressure at a nearby well and consequently alters its pressure-rate response. Another example is that flow rate change at an adjacent well may affect the interwell flow direction or rate.

On the other hand, the interwell communications response and the pressure-rate response at individual wells assume distinctly different characteristics. First, the time constants in both cases differ by orders of magnitude due to the scale difference between a wellbore and an interwell communication path, and difference in flow dynamics (fast disturbance propagation in the wellbore verse slow diffusion in the reservoir). Second, the response shape appears differently in each case. Due to the longer and more complex flow path between two wells, the interwell communication response can be expected to have a less uniform and more complex functional form of weaker magnitude than the build-up or drawdown response at a single well.

Based on these observations, an exemplary embodiment of the present techniques relates to a joint well model in which the local pressure-to-rate response and the interwell connectivity response are first treated differently, but then combined coherently into a state-space equation where the downhole pressures at all the involved wells constitute the state vector. More specifically, in the presence of interwell connectivity the downhole pressures are modeled by a high-order vector auto-regressive (AR) process to reflect the communications among the wells. In general pressure data is more reliable than production rate data which is one of the reasons to choose pressure as the state vector. The interwell connectivites are assumed to change slowly with time due to changes in the reservoir parameters or fluid or flow conditions. However, no explicit functional form of the coefficients is needed. The coefficients are estimated from the data and hence can be expected to vary automatically over time.

According to an exemplary embodiment, the flow rates at all wells become the input (or control) term in the state space equation in the form of the pressure-to-rate response at each individual well. Doing so allows separate modeling of the local well dynamics from the interwell communications and then combining them using the Superposition principle, which simplifies the problem. Due to the significant scale difference in the time constants for interwell communications and those for single well pressure response, such decoupling is a reasonable approximation. As a result, the model effectively generates a network graph where the leaf nodes are the individual wells whose rate to-pressure response is superposed upon the interwell connection network, as represented in FIG. 3. Based on the pressure and rate data from all the involved wells, the algorithms then estimate both the auto-regressive coefficients characterizing the interwell connectivity and the pressure-to-rate response function at each individual well.

More specifically, consider the following equations:

$$\begin{matrix}p [ n ] = {\sum }_{l = 1}^{L} {A}_{1} p [ n - l ] + Gq [ n ] + w [ n ] & ( 5 ) \\ y [ n ] = f ( p [ n ] ) + v [ n ] & ( 6 )\end{matrix}$$

where G=[g₁ g₂ . . . g_{N}] contains the self-response at all the wells. y[n] represents the measured pressure at different locations inside the well and is related with the true well pressure p[n] in the form of f(p[n]) which is assumed known (in most cases one can simply assume f(p[n])=p[n] if f(.) is not known exactly. In this manner, the measured pressure is essentially a noisy version of the true pressure. v[n] denotes the measurement error and noise effects.

When A₁=0, equations (5)-(6) represent a set of decoupled equations characterizing individual well dynamics without interwell interference. On the other hand, when q[n]=0, i.e. in the absence of production, equation (5) will converge to an equilibrium pressure level throughout the reservoir, provided the system is stable (i.e. the eigenvalues of A₁ are within the unit circle).

For equations (5) and (6), multiwell reservoir analysis becomes a tradeoff between estimating A₁ and G, which together characterize the interwell communication and the pressure-rate response at each well. Given A₁ and G, the system response functions of the multiwell model could be calculated using equation (5), which yields both the constant flow production pressure response at individual wells as well as the communication response among all the wells. The communication response may be represented as the pressure drop responses at well I to production rate change at all the other wells.

### Reservoir Analysis Via Model-Based Dynamic Learning

FIG. 4 is a block diagram of a system 400 for performing a reservoir analysis according to an exemplary embodiment of the present techniques. The system 400 includes a forward joint well model portion 402, a learning model portion 404, a well testing based selective learning portion 406, two sparsity constraint portions 408, and a robust learning portion 410.

The multiwell model described previously provides a general dynamic structure against which the pressure and production rate measurements can be fitted to produce the model coefficients. More specifically

(Â,Ĝ)=argmin_{A,G}J(A,G) (7)

where A=[A₁, . . . A_{L}]; J(A,G) is a metric function which is made up of multiple terms, including Jₒ the error between the measurements and the model outputs:

J₀=Σ∥y[n]−ŷ[n]∥_{Q}_{₀}² (8)

The sum may be over a certain observation time window. Details about the other terms are given later in this section.

Minimizing J(A,G) from equation (7) gives the optimal estimates Â,Ĝ. Once the coefficients are estimated, the model represented in equations (5)-(6) represents a complete characterization of the multiwell behavior. The impulse/step responses of the pressure drops to the production rates at each individual well itself as well as from all other wells may be obtained. These response functions can be further processed to estimate the reservoir physical parameters for further interpretation. The algorithms developed herein address four issues arising in analyzing real multiwell data. The first issue is over-parameterization due to relatively long interwell time delays coexisting with short single well response time. Both are typically unknown a priori. The second issue is robustness against unreliable data, especially unreliable production rate data. The third issue is response selectivity associated with a specific testing well. The fourth and final issue is the need for adaptive tracking of the variation trends of reservoir characteristic parameters over production time.

Additionally, the model and the algorithmic structure of the system 400 provide a framework to derive the optimal well testing strategy at a given reservoir field for the purpose of multiwell connectivity analysis and reservoir characterization. Moreover, an exemplary embodiment relates to determining a minimal required well testing signal in order to accurately estimate the reservoir parameters.

A challenge to the performance of multiwell analysis is over-parameterization, which is caused by both the increased number of wells and the time delay/span for interwell response. Left unaddressed, these issues will likely cause ill-conditioning in coefficient estimation. An exemplary embodiment of the present techniques overcomes this issue by imposing two types of constraints on a vector including the coefficients of all the responses. The first constraint (represented at block 408a) is mathematical sparsity. The second constraint (represented at block 408b) is any prior knowledge about the delay location of the coefficients. In general, either the single-well or interwell response has a relatively concentrated time support beyond which the response coefficients have negligible magnitude. Stacked together, these response coefficients form an elongated vector in which nonzero components form clusters and appear group sparse. Imposing such sparsity constraints will enforce this structure and reduce over-parameterization. On the other hand, given a producing reservoir field, certain prior knowledge about the well geometry or the delay lag between wells may be known, e.g. from early testing results. This a priori information may be incorporated as constraints on the coefficient delay locations. As a result the following two penalty terms may be applied:

J₁=∥vec([A^{t}G^{t}])∥ₚ, 0≦p≦1 (9)

J₂=∥vec([A^{t}G^{t}])|_{Q}_{₁}², (10)

where J₁ represents the group sparsity constraint and J₂ is associated with the a priori knowledge. Here, ∥ ∥ₚ denotes the lₚ norm and ∥ ∥_{Q}_{₁}² is the l₂ norm weighted by the matrix Q₁. Q₁ has large diagonal values (restrictive constraints) at delay regions where no significant coefficients should be expected a priori; and has small diagonal values elsewhere.

Robustness to unreliable data (represented at block 410) is also important in real well analysis. Both the pressure and production rate measurements can be very noisy or even missing over time. As a result, the algorithms are desirably robust against these issues in order to be practically useful. In an exemplary embodiment, the data uncertainty may be quantified and incorporated into coefficient estimation. The following represents a total least squares formulation:

J₃=Σ∥[y[n]−ŷ[n]α\tilde{q}[n]∥_{F}_{_{w}} (11)

where ∥ ∥_{F}_{_{w}} is the weighted Frobenius norm and \tilde{q}[n]=q[n]−qₘₑₐₛ[n].
The term “response selectivity” refers to the fact that, given a testing well Wⱼ, the response between any pair of wells Wᵢ and Wₖ for i, k≠j estimated from the data can be ambiguous in various ways. For instance, in response to testing excitation at well Wⱼ, both wells Wᵢ and Wₖ may have correlated pressure fluctuations separated in time by an amount much smaller than the propagation delay from Wᵢ to Wₖ. Hence, using this data will likely produce a false estimate of interwell response between Wᵢ and Wₖ. To overcome this type of ambiguity, an adaptive learning method (represented at block 404) may be used in which the model coefficients associated with the responses directly excited by the testing well are actively updated while the other coefficients are left in a dormant or slow learning mode. This is realized via a switching model based adaptive learning scheme. Switching between the set of actively updated coefficients is controlled either by the choking signal provided to the well testing-based selective learning portion 406 at a given time or batch processing based well event detection algorithms which determine an adaptive masking matrix S[n] as shown in FIG. 4. More specifically, the updating of model coefficients may be modified to reflect this well-testing based selectivity, as follows:

vec[ÂĜ][n]=vec[ÂĜ][n−1]+diag(s[n])vec[ΔAΔG][n] (12)

where [ΔA ΔG][n] is the regular error update components. For instance [ΔA ΔG][n]=K[n]e[n] in Kalman filter based updating; the elements of the vector s[n] are given as

sᵢ[n]=1, if i∈I_{active} (13)

sᵢ[n]=ε, otherwise (14)

As used herein, the notation vec converts a matrix into a long vector with all its columns stacked on top of each other.

This selectivity based learning may also adaptively adjust to the information content in the data regardless of which wells are being tested and allows the use of production data for well analysis in the absence of well testing. For instance, in the lack of well testing and that the data is mainly generated by production, the coefficients are updated at a slower learning step assuming that the production data is not as information rich as the well testing data. Once well testing is detected from the choking signal, then the appropriate subset of coefficients are actively updated. One advantage of this well-testing based selective learning is that, sequentially, it maintains the continuity of the learning process, unlike most batch processing in which the parameters essentially are estimated anew for every data block.

To summarize, the algorithm minimizes the following cost function:

J(A,G)=+J₁+λ₂J₂+λ₃J₃ (15)

while during minimization, the coefficient update is modified according to equation (12). λ₂, λ₃ weighting coefficients and J₁, J₂, J₃ are given in equations (9), (10) and (11) respectively.

Once the model parameters have been estimated, either the impulse/step responses or any transfer functions of the system may be obtained. This can be achieved by using the multivariate AR model structure.

### Interpretation Model

Model-based learning algorithms according to the present techniques generate a set of model coefficients that, together with the model structure, define a complete characterization of both interwell communication that can be readily calculated from the model coefficients. The task of interpretation is to take these functions as input and to compute the values and trends of the reservoir physical parameters, including the effective permeability between wells and the local properties such as the skin factor, the permeability, the compressibility, the viscosity, and the like. Derivative curve fitting has been performed in a context of single well analysis. According to the present techniques, the connection between the system response functions and the set of reservoir parameters may be made via the Green's functions, which may be parameterized by the reservoir parameters. The system response functions, converted into the frequency domain, directly yield estimates of the corresponding Green's functions. Based on the parametric form of the Green's function, these reservoir parameters may be estimations as well as the dynamics at each individual well, represented by a set of system response functions ed from the Fourier transformed response function generated by the learning algorithms.

According to the present techniques, Green's function, H, may be introduced by considering an inhomogeneous diffusion equation in the frequency domain:

jωSH(r/rⱼ,ω)−∇·(K∇H(r/rⱼ,ω))=δ(r−rⱼ) (16)

where the reservoir specific storage coefficient

S=ρ₀c (17)

and the reservoir conductivity coefficient

$$K = {ρ}_{0} \frac{κ}{φ μ} \qquad ( 18 )$$

The pressure response at location rᵢ to a point source of flow rate change (e.g., shut-in at wellhead) at location rⱼ is given by

Pᵢ(ω)=Hᵢⱼ(ω)Qⱼ(ω) (19)

Within the well when i=j, the Green's function is equal to the Fourier transform of impulse response function of G in equation (5). Between receiving well j and excitation well i, the Green's function is given by the product

Hᵢⱼ(ω)=HᵢᵢTᵢⱼ (20)

where Tᵢⱼ is the transmission function and equal to the Fourier transform of AR coefficient A in the equation (5).

Depending on the nature of a reservoir, the Green's function can be parameterized with reservoir properties. Those parameters can then be estimated from the data analysis method in this invention. For example, consider a homogeneous one-dimensional reservoir. For this reservoir, the Green's function may be modeled as:

$$\begin{matrix}{G}_{ij} ( ω ) = {b}_{0} {e}^{- \frac{\sqrt{2 ω}}{2} σ \vert {x}_{i} - {x}_{j} \vert} {e}^{j \frac{\sqrt{2 ω}}{2} σ \vert {x}_{i} - {x}_{j} \vert} = \vert {G}_{ij} \vert {e}^{j Δ {φ}_{ij}} & ( 21 ) \\ \vert {G}_{ij} ( ω ) \vert = {b}_{0} {e}^{- \frac{\sqrt{2 ω}}{2} σ \vert {x}_{i} - {x}_{j} \vert} & ( 22 ) \\ Δ {φ}_{ij} ( ω ) = \frac{\sqrt{2 ω}}{2} σ \vert {x}_{i} - {x}_{j} \vert & ( 23 )\end{matrix}$$

The parameter of reservoir to be estimated is

$$σ = \sqrt{\frac{S}{K}} \qquad ( 24 )$$

### EXAMPLES

The following examples represent results obtained from a synthesized three-well reservoir with three different interwell connectivity scenarios.

Case I: Homogeneous Reservoir with Background Permeability of K=100 md

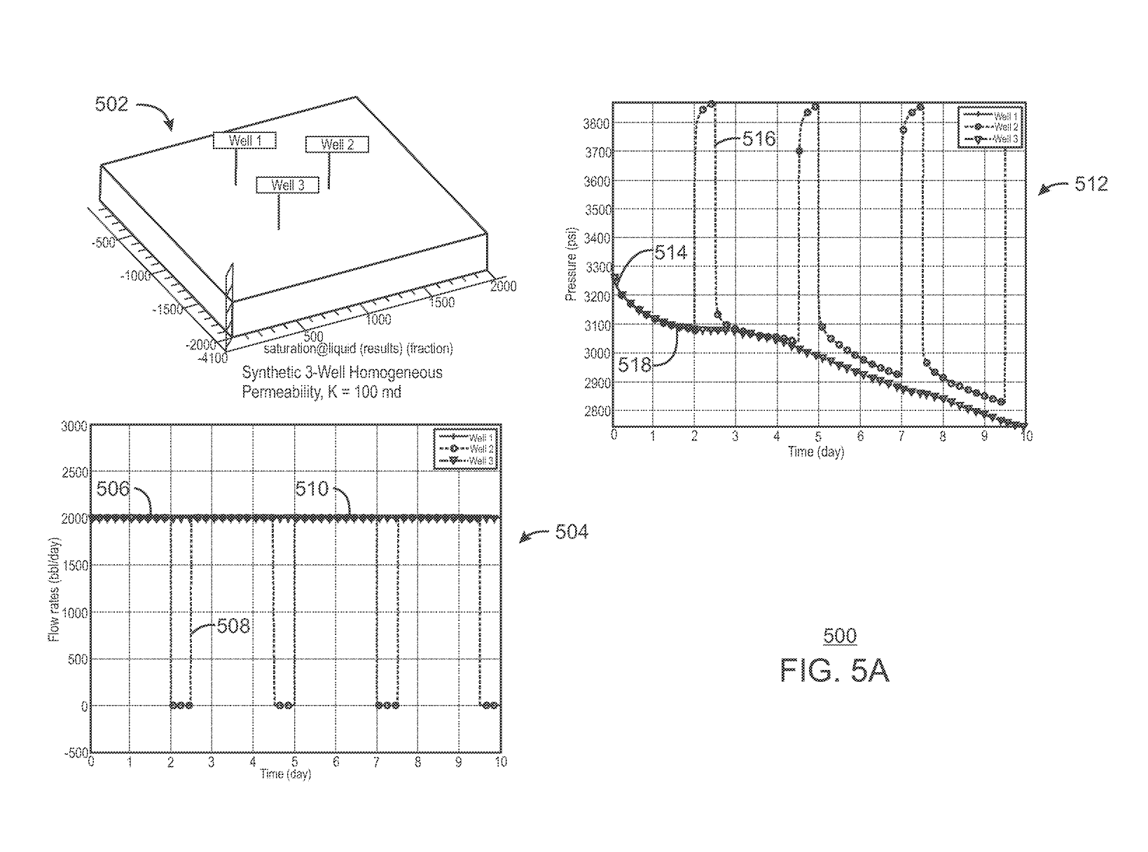

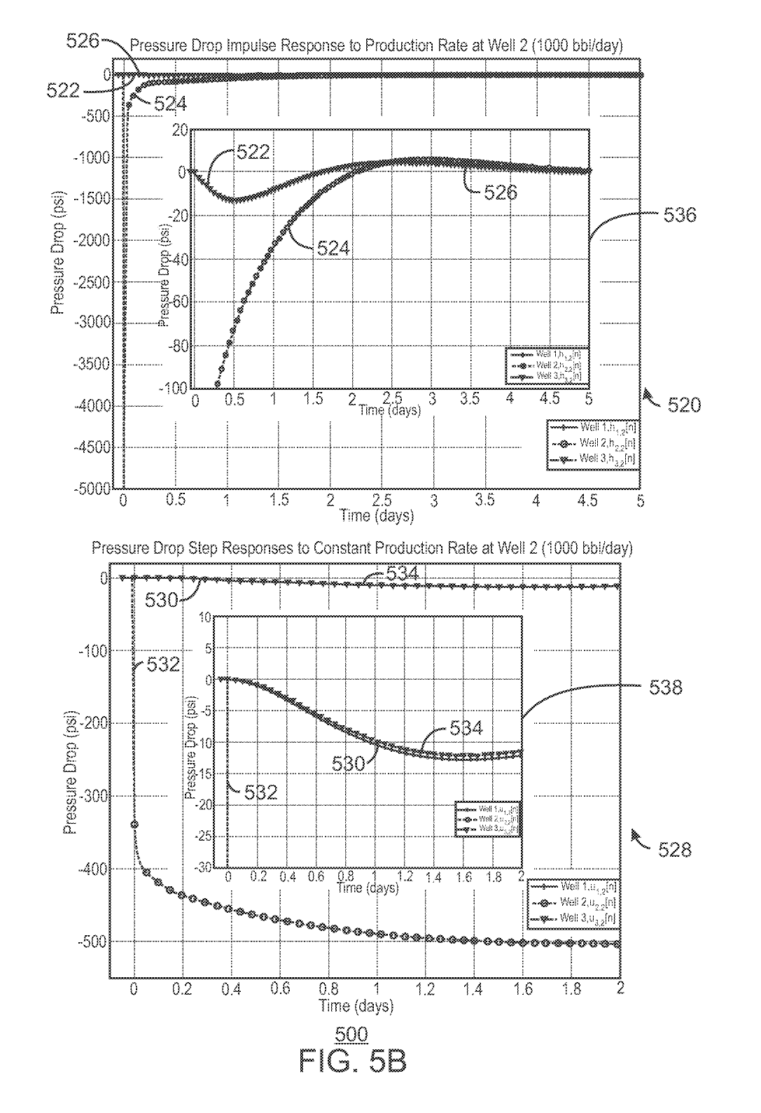

FIG. 5, which includes FIGS. 5A and 5B, is a collection 500 of panels showing an example of a synthetic three-well reservoir with homogeneous permeability, along with graphs showing simulation results therefor, according to an exemplary embodiment of the present techniques. The synthetic reservoir, which has three wells, is schematically shown in a first panel 502. The three wells are labelled Well 1, Well 2 and Well 3 in the first panel 502.

A second panel 504 is a graph showing production at each of the three producer wells of the synthetic reservoir shown in the first panel 502. In the second panel 504, the production of Well 1 is shown by a trace 506. The production of Well 2 is shown by a trace 508. The production of Well 3 is shown by a trace 510. Among the three wells, the traces 506 and 510 show that Well 1 and Well 3 each produce constantly at a rate of 2,000 bbl/day while Well 2, represented by the trace 508, undergoes periodic well shut-in (production goes to zero).

A third panel 512 is a graph showing the pressure response of Well 1, Well 2 and Well 3. The pressure response of Well 1 is shown by a trace 514. The pressure response of Well 2 is shown by a trace 516. The pressure response of Well 3 is shown by a trace 518.

By providing these measurements to the model represented by equations (23)-(24), the coefficient matrices A_{I} and G may be estimated. The resulting system can be represented by its impulse/step responses, which in this case are the pressure impulse/step responses to production rates. In particular, a fourth panel 520 (FIG. 5B) is a graph showing a pressure drop impulse response at all three wells attributable to a production rate impulse at well II of 1,000 barrels (bbl). A trace 522 shows the impulse response for Well 1. The impulse response for Well 2 is shown by a trace 524. A trace 526 shows the impulse response for Well 3. A zoom plot 536 shows an enhanced view of a region of the data in the fourth panel 520.

Corresponding step responses are shown in a fifth panel 528 (FIG. 5B), which is a graph showing a pressure drop step response attributable to a constant production rate at well II of 1,000 barrels per day. A trace 530 shows the pressure step response for Well 1. The pressure step response for Well 2 is shown by a trace 532. A trace 534 shows the pressure step response for Well 3. A zoom plot 538 shows an enhanced view of a region of the data in the fifth panel 528.

From the data shown in FIG. 5, the responses at Well 2 itself are significantly stronger and with shorter delay than the interwell responses at Well 1 and Well 3. Also the responses at well I and III are similar, which is consistent with the homogeneous permeability assumption. The step responses can then either be provided to a reservoir engineer for derivative pressure curve analysis or subject to further interpretation for reservoir structural parameter estimation.

Case II: Homogeneous Reservoir with Background Permeability of K=100 md, Barrier of K=10 md Between Well II and III

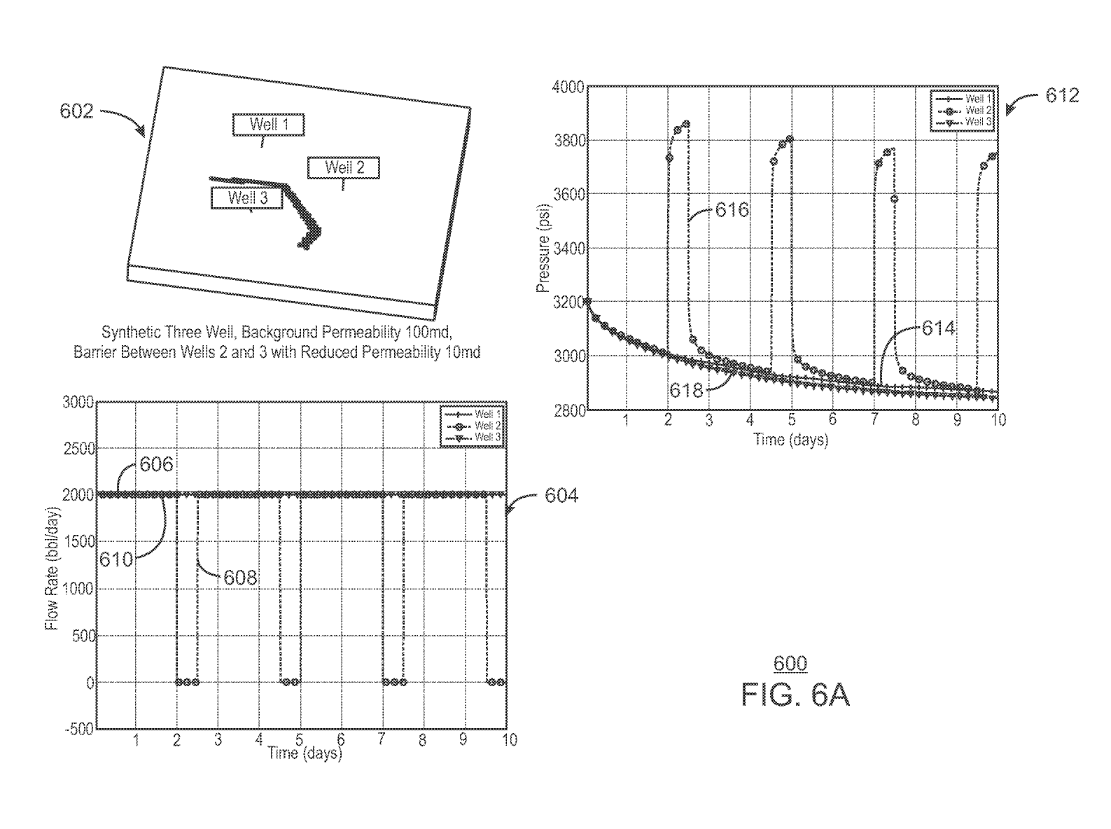

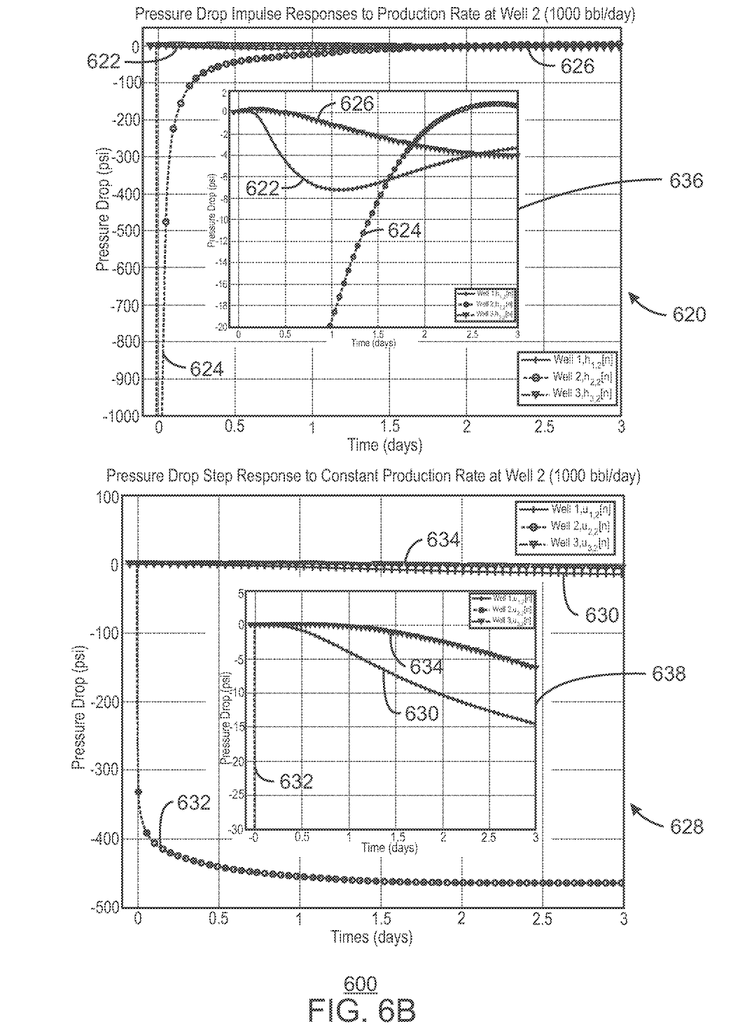

FIG. 6, which includes FIGS. 6A and 6B, is a collection 600 of panels showing an example of a synthetic three-well reservoir with homogeneous permeability, and one barrier between two of the wells, along with graphs showing simulation results therefor, according to an exemplary embodiment of the present techniques. The synthetic reservoir, which has three producer wells, is schematically shown in a first panel 602. The three producer wells are labelled Well 1, Well 2 and Well 3 in the first panel 602. As shown in the first panel 602, a barrier is present between Well 2 and Well 3. The background permeability is the same as for the example shown in FIG. 5, with the exception that the barrier provides K=10 and between Well 2 and Well 3.

A second panel 604 shows well production at each of the three wells depicted in the first panel 602. A first trace 606 represents the production of Well 1. Production of Well 2 is shown by a trace 608. A trace 610 shows the production of Well 3. As in FIG. 5, among the three wells, Well 1 and Well 3 produce constantly at a rate of 2,000 bbl/day while well II undergoes periodic well shut-in. The resulting wellbore pressure curves are also shown in FIG. 6A. In particular, a third panel 612 is a graph showing pressure at each of the three producer wells of the synthetic reservoir. A trace 614 shows the pressure at Well 1. The pressure at Well 2 is shown by a trace 616. A trace 618 shows the pressure at Well 3.

The pressure drop impulse responses at all three wells to a production rate impulse at Well 2 to constant production rates are shown in a fourth panel 620. A trace 622 shows the impulse response for Well 1. The impulse response for Well 2 is shown by a trace 624. A trace 626 shows the impulse response for Well 3. A zoom plot 636 shows an enhanced view of a region of the data in the fourth panel 620.

A fifth panel 628 shows the pressure step response at each of the three wells in the simulation. A trace 630 shows the step response for Well 1. The step response for Well 2 is shown by a trace 632 and the step response for Well 3 is shown by a trace 634. A zoom plot 638 shows an enhanced view of a region of the data in the fifth panel 638. As with the example shown in FIG. 5, the responses at Well 2 itself are significantly stronger and with shorter delay than the interwell responses at Well 1 and Well 3. In the example shown in FIG. 6, however, the responses at well I and III are quite different. In fact, Well 3 shows much smaller responses and significantly longer delay, which is consistent with the barrier set up between Well 2 and Well 3.

Case III: Homogeneous Reservoir with Background Permeability of K=100 md, Channel of K=500 md Between Well II and III

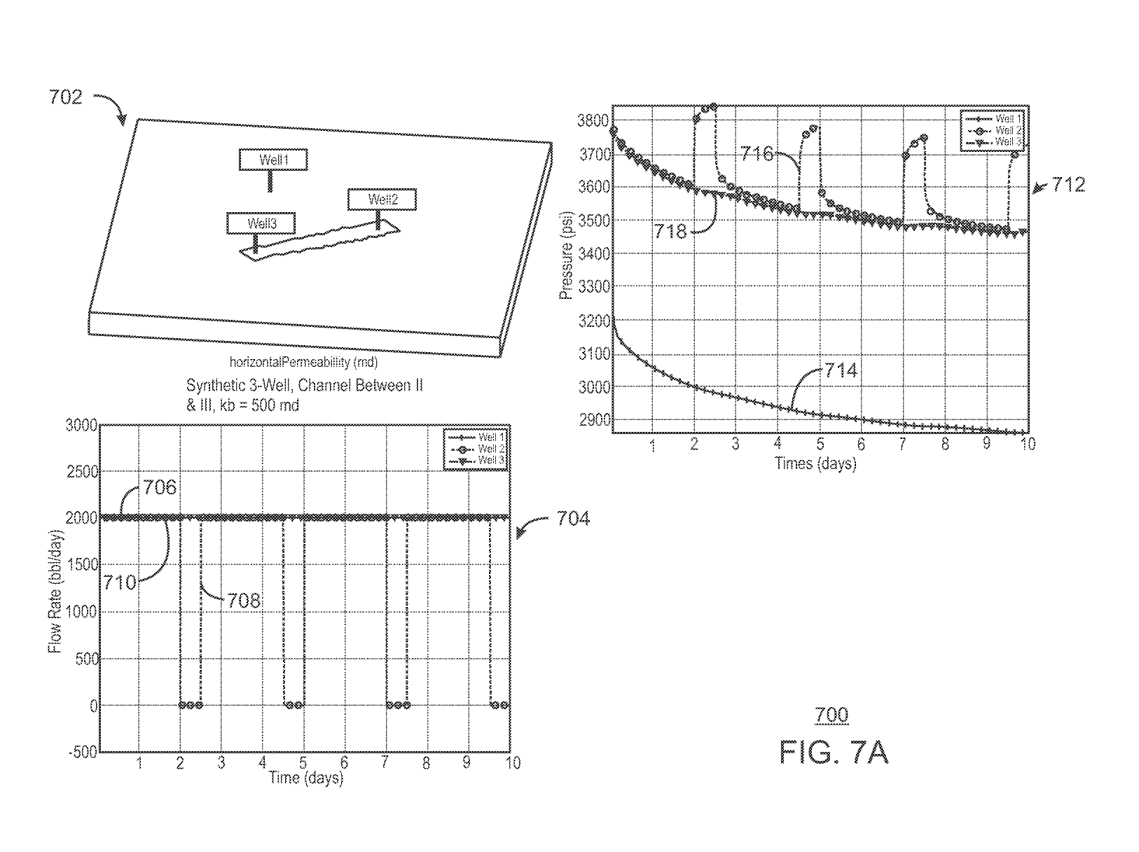

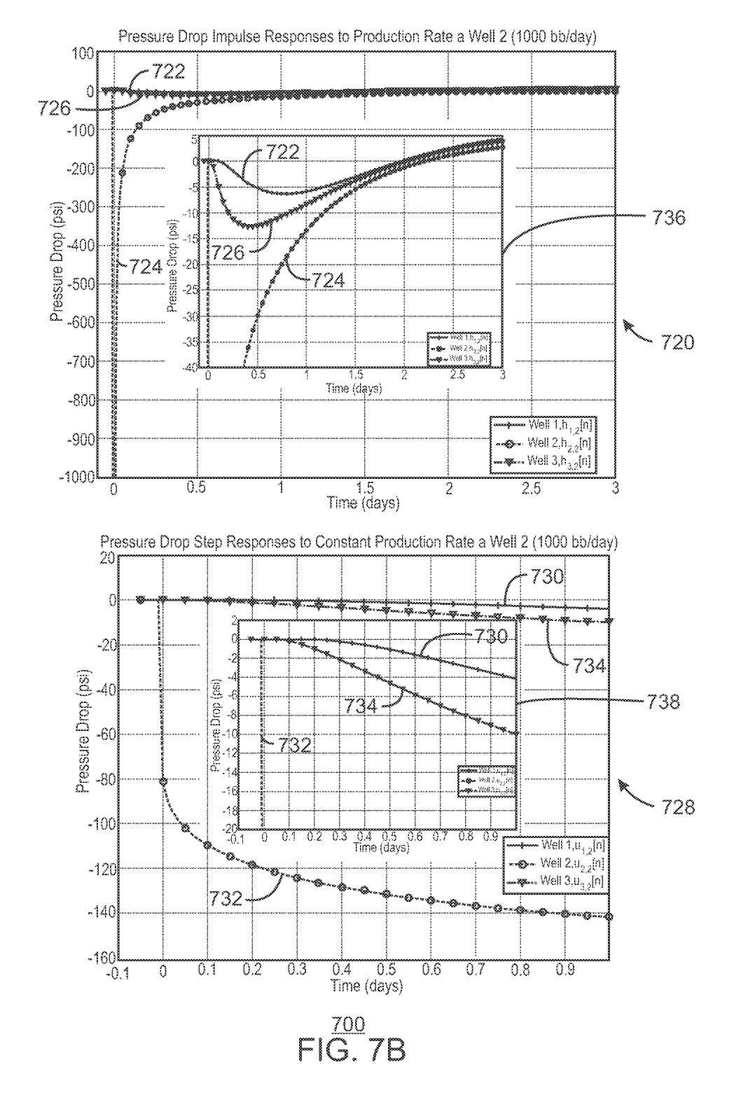

FIG. 7, which includes FIGS. 7A and 7B, is a collection of panels showing an example of a synthetic three-well reservoir with homogeneous permeability, and one channel between two of the wells, along with graphs showing simulation results therefor, according to an exemplary embodiment of the present techniques. The synthetic reservoir, which has three producer wells, is schematically shown in a first panel 702. The three producer wells are labelled Well 1, Well 2 and Well 3 in the first panel 702. As shown in the first panel 702, a channel is present between Well 2 and Well 3. The background permeability is the same as for the examples shown in FIG. 5 and FIG. 6, with the exception that the channel provides K=500 and between Well 2 and Well 3 in the first panel 702.

A second panel 704 is a graph showing production at each of the three producer wells of the synthetic reservoir shown in the first panel 702. In the second panel 704, the production of Well 1 is shown by a trace 706. The production of Well 2 is shown by a trace 708. The production of Well 3 is shown by a trace 710. Among the three wells, Well 1 and Well 3 produce constantly at a rate of 2,000 bbl/day while Well 2 undergoes periodic well shut-in. The resulting wellbore pressure curves are also shown in FIG. 7A. In particular, a third panel 712 is a graph showing pressure at each of the three producer wells of the synthetic reservoir. A trace 714 shows the pressure at Well 1. The pressure at Well 2 is shown by a trace 716. A trace 718 shows the pressure at Well 3.

The pressure drop impulse responses at all three wells to a production rate impulse at Well 2 to constant production rates are shown in a fourth panel 720. A trace 722 shows the impulse response for Well 1. The impulse response for Well 2 is shown by a trace 724. A trace 726 shows the impulse response for Well 3. A zoom plot 736 shows an enhanced view of a region of the data in the fourth panel 720.

A fifth panel 728 shows the pressure step response at each of the three wells in the simulation. A trace 730 shows the step response for Well 1. The step response for Well 2 is shown by a trace 732 and the step response for Well 3 is shown by a trace 734. A zoom plot 738 shows an enhanced view of a region of the data in the fifth panel 738.

An exemplary embodiment may employ sparsity enforced parameter estimates. Sparsity enforced parameter estimation refers to imposing in the objective function a penalty term J2 given in equation (10). which effectively sets non-relevant parameters to zero. Therefore, the so-called overparamterization issue discussed herein is avoided. Potential benefits of using sparsity enforced parameter estimation may include the prevention of overfitting of the model by spurious parameters and improvement in predictive performance.

In an exemplary embodiment, noise may be added during a simulation to show noise sensitivity.

As with the other examples shown herein, the responses at Well 2 itself is significantly stronger than the interwell responses at Well 1 and Well 3. Moreover, the pressure drop impulse response of Well 3 indicated by trace 726 has an earlier and greater pressure drop in comparison to the pressure drop impulse response of Well 1 indicated by trace 722.

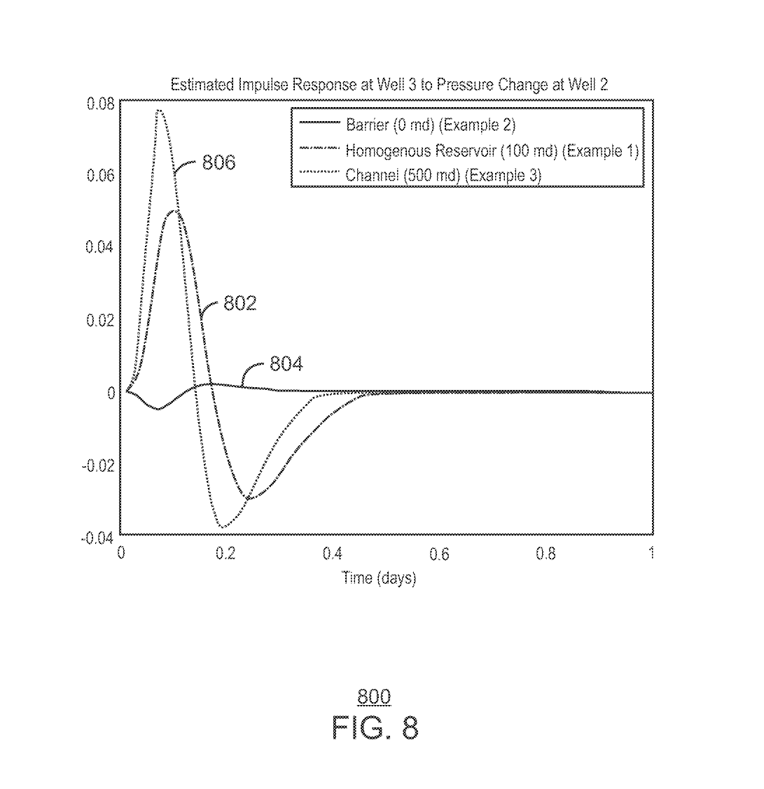

FIG. 8 is a graph 800 showing a comparison of impulse response estimates according to an exemplary embodiment of the present techniques. The graph 800 includes a trace 802, which represents the impulse response of a homogeneous reservoir, such as Example 1 discussed herein. The impulse response for a reservoir having a barrier between two wells is shown by a trace 804. The case of a barrier between wells is discussed herein with reference to Example 2. A trace 806 represents the impulse response for a reservoir having a channel between two wells. This condition is discussed herein with reference to Example 3.

To obtain the data represented in the graph 800, the parameters are obtained by regressing the pressure differential at the target well against delayed versions of pressure differentials at exciting wells and then enforcing the optimum bulk delay and response spread through the use of suitable priors. The estimated parameters are directly interpretable as the impulse response of the pressure differential at the target well to a change in pressure at the exciting well.

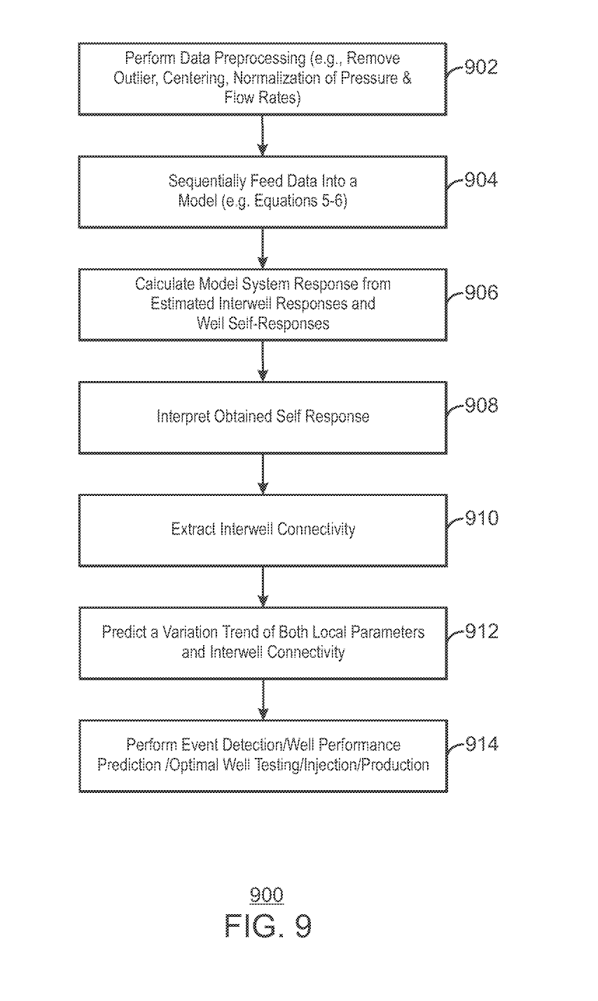

FIG. 9 is a process flow diagram showing a method 900 of a method of performing an analysis of well communication according to an exemplary embodiment of the present techniques. At block 902, data pre-processing is performed on data corresponding to properties of multiple wells that make up a reservoir. Examples of data that may be used include pressure, flow rate, porosity, permeability or the like. Data pre-processing may include de-noising data, removing clutter, centering, normalizing pressure and flow rates or the like.

At block 904, the well data is sequentially fed into a model that is designed to estimate interwell responses for combinations of wells and self-responses for each well individually. An example of such a model is represented herein by equations (5) and (6). Learning algorithms such as robust sparsity estimation or switching learning may be applied, as explained herein. The model may estimate parameters representative of interwell communication and well self-responses may by minimizing a cost function. An example of such a cost function is set forth as equation (15) herein.

From the estimated interwell communication parameters and self-response parameters, a model system response may be calculated, as shown at block 906. The self-responses, which may be represented as pressure derivative curves, may be interpreted, as shown at block 908. Local parameters may be derived using, equations such as equations (16)-(24) set forth herein. As shown at block 910, interwell connectivity may be extracted by, for example, interpreting the estimated interwell responses.

At block 912, a variation trend of both local parameters and interwell connectivity may be predicted. According to the present techniques, other activities that may be performed include event detection, well performance prediction, and obtaining optimal well testing, injection and production data, as shown at block 914.

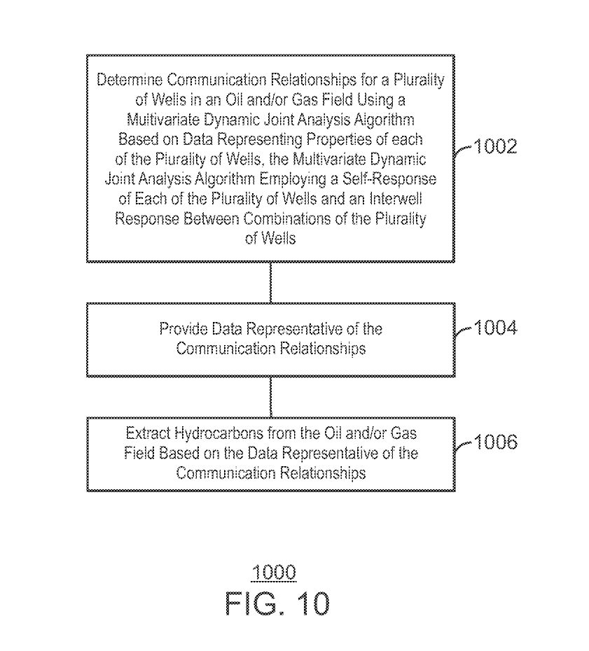

FIG. 10 is a process flow diagram showing an exemplary method 1000 for producing hydrocarbons from an oil and/or gas field according to exemplary embodiments of the present techniques. The method 1000 for producing hydrocarbons employs a reservoir simulation of the oil and/or gas field.

At block 1002, communication relationships for a plurality of wells in the oil and/or gas field are determined using a multivariate dynamic joint analysis algorithm based on data representing properties of each of the wells. As explained herein, the multivariate dynamic joint analysis algorithm may employ a self-response of each of the wells and an interwell response between combinations of the wells.

Data representative of the communication relationships is provided, as shown at block 1004. Based on the communication relationship data, hydrocarbons are extracted from the oil and/or gas, as shown at block 1006.

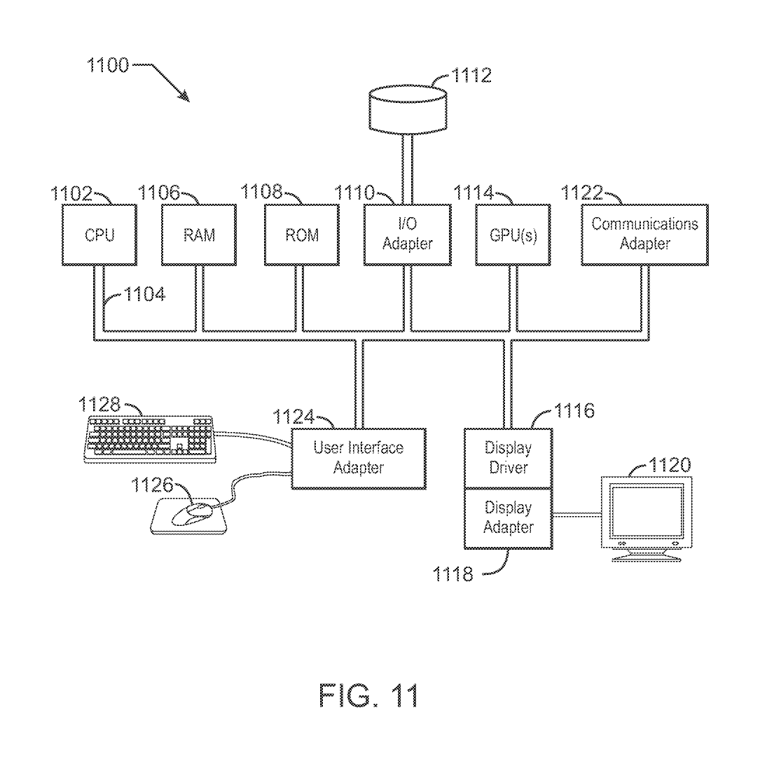

FIG. 11 is a block diagram of a computer system that may be used to perform a method for summarizing data corresponding to a property of interest on an unstructured grid according to exemplary embodiments of the present techniques. The computer system is generally referred to by the reference number 1100. A central processing unit (CPU) 1102 is coupled to system bus 1104. The CPU 1102 may be any general-purpose CPU, although other types of architectures of CPU 1102 (or other components of exemplary system 1100) may be used as long as CPU 1102 (and other components of system 1100) supports the inventive operations as described herein. Those of ordinary skill in the art will appreciate that, while only a single CPU 1102 is shown in FIG. 11, additional CPUs may be present. Moreover, the computer system 1100 may comprise a networked, multi-processor computer system. The CPU 1102 may execute the various logical instructions according to various exemplary embodiments. For example, the CPU 1102 may execute machine-level instructions for performing processing according to the operational flow described above in conjunction with FIG. 9 or FIG. 10.

The computer system 1100 may also include computer components such as computer-readable storage media. Examples of computer-readable storage media include a random access memory (RAM) 1106, which may be SRAM, DRAM, SDRAM, or the like. The computer system 1100 may also include additional computer-readable storage media such as a read-only memory (ROM) 1108, which may be PROM, EPROM, EEPROM, or the like. RAM 1106 and ROM 1108 hold user and system data and programs, as is known in the art. The computer system 1100 may also include an input/output (I/O) adapter 1110, a communications adapter 1122, a user interface adapter 1124, and a display adapter 1118.

The I/O adapter 1110 preferably connects a storage device(s) 1112, such as one or more of hard drive, compact disc (CD) drive, floppy disk drive, tape drive, etc. to computer system 1100. The storage device(s) may be used when RAM 1106 is insufficient for the memory requirements associated with storing data for operations of embodiments of the present techniques. The data storage of the computer system 1100 may be used for storing information and/or other data used or generated as disclosed herein.

The computer system 1100 may comprise one or more graphics processing units (GPU(s)) 1114 to perform graphics processing. Moreover, the GPU(s) 1114 may be adapted to provide a visualization useful in performing a well planning process according to the present techniques. The GPU(s) 1114 may communicate via a display driver 1116 with a display adapter 1118. The display adapter 1118 may produce a visualization on a display device 1120. Moreover, the display device 1120 may be used to display information or a representation pertaining to a portion of a subsurface region under analysis, such as displaying communication data between wells, according to certain exemplary embodiments.

In an exemplary embodiment of the present techniques, the display adapter 1118 may be adapted to provide a 3D representation of data representative of communication between wells in a reservoir. Moreover, an exemplary embodiment of the display adapter 1118 may comprise a visualization engine that is adapted to provide a visualization of such communication data. The I/O adapter 1110, the user interface adapter 1124, and/or communications adapter 1122 may, in certain embodiments, enable a user to interact with computer system 1100 in order to input information.

A user interface adapter 1124 may be used to couple user input devices. For example, the user interface adapter 1124 may connect devices such as a pointing device 1126, a keyboard 1128, and/or output devices to the computer system 1100.

The architecture of system 1100 may be varied as desired. For example, any suitable processor-based device may be used, including without limitation personal computers, laptop computers, computer workstations, and multi-processor servers. Moreover, embodiments may be implemented on application specific integrated circuits (ASICs) or very large scale integrated (VLSI) circuits. In fact, persons of ordinary skill in the art may use any number of suitable structures capable of executing logical operations according to the embodiments.

The present techniques may be susceptible to various modifications and alternative forms, and the exemplary embodiments discussed above have been shown only by way of example. However, the present techniques are not intended to be limited to the particular embodiments disclosed herein. Indeed, the present techniques include all alternatives, modifications, and equivalents falling within the spirit and scope of the appended claims.

### Embodiments

An embodiment described herein provides a method for determining interwell communication in a hydrocarbon-producing field that has a number of wells. The method includes determining communication relationships for the wells using a multivariate dynamic joint analysis algorithm based on data representing properties of each of the plurality of wells. The multivariate dynamic joint analysis algorithm employs a self-response of each of the wells and an interwell response between combinations of the plurality of wells. Data representative of the communication relationships is provided.

The self-response may include a pressure-rate response. The method may include solving for the self-response of each of the wells and the interwell responses using a cost function. The data representative of the communication relationships may include a superposition based on the self-response of each of the wells and the interwell response between combinations of the wells. The method may include calculating a model system response based on the self-response of each of the wells and the interwell response between combinations of the wells.

In an embodiment, determining communication relationships may include applying a learning algorithm. The learning algorithm may include additional regularization terms that promote sparsity and/or robustness. The model parameterization and regularization may use additional side information from experts or alternate reservoir/well models. The learning algorithm may include a switching learning algorithm.

The method may include deriving local parameters for each of the wells by interpreting data related to the self responses. The data representing properties of each of the wells may include one or more of the following: bottomhole pressure, surface pressure, production rate, injection rate, and/or wellbore temperature. The method may include pre-processing the data representing properties of each of the wells using one or more of the following: de-noising, rapid scoping, and/or segmentation. A visualization of the data representative of the communication relationships may be displayed.

An embodiment described herein provides a computer system that determines interwell communication in a hydrocarbon-producing field that has a number of wells. The computer system may include a processor and a non-transitory, computer-readable storage medium that stores computer-readable instructions for execution by the processor. The computer-readable instructions may include code that causes the processor to determine communication relationships for the wells using a multivariate dynamic joint analysis algorithm based on data representing properties of each of the wells. The multivariate dynamic joint analysis algorithm may employ a self-response of each of the wells and an interwell response between combinations of the wells. The instructions may include code that causes the processor to provide data representative of the communication relationships.

In an embodiment, the self-response may include a pressure-rate response. A computer system may include code that causes the processor to solve for the self-response of each of the wells and the interwell responses using a cost function. Data representative of the communication relationships may include a superposition based on the self-response of each of the wells and the interwell response between combinations of the wells.

Code in an embodiment may cause the processor to calculate a model system response based on the self-response of each of the wells and the interwell response between combinations of the wells. Additional code may cause the processor to display a visualization of the data representative of the communication relationships.

An embodiment described herein provides a method for producing hydrocarbons using a determination of interwell communication in an oil and/or gas field that has a number of wells. The method includes determining communication relationships for the wells in the oil and/or gas field using a multivariate dynamic joint analysis algorithm based on data representing properties of each of the wells. The multivariate dynamic joint analysis algorithm may employ a self-response of each of the wells and an interwell response between combinations of the wells. Data representative of the communication relationships is provided. Hydrocarbons are extracted from the oil and/or gas field based on the data representative of the communication relationships. An embodiment may include displaying a visualization of the data representative of the communication relationships.

What is claimed is:

1. A method for determining interwell communication in a hydrocarbon-producing field that has a plurality of wells, the method comprising:
determining communication relationships for the plurality of wells using a multivariate dynamic joint analysis algorithm based on data representing properties of each of the plurality of wells, the multivariate dynamic joint analysis algorithm employing a self-response of each of the plurality of wells and an interwell response between combinations of the plurality of wells; and
providing data representative of the communication relationships.

2. The method recited in claim 1, wherein the self-response comprises a pressure-rate response.

3. The method recited in claim 1, comprising solving for the self-response of each of the plurality of wells and the interwell responses using a cost function.

4. The method recited in claim 1, wherein the data representative of the communication relationships comprises a superposition based on the self-response of each of the plurality of wells and the interwell response between combinations of the plurality of wells.

5. The method recited in claim 1, comprising calculating a model system response based on the self-response of each of the plurality of wells and the interwell response between combinations of the plurality of wells.

6. The method recited in claim 1, wherein determining communication relationships comprises applying a learning algorithm.

7. The method recited in claim 6, wherein the learning algorithm comprises additional regularization terms that promote sparsity and/or robustness.

8. The method recited in claim 6, wherein the model parameterization and regularization use additional side information from experts or alternate reservoir/well models.

9. The method recited in claim 6, wherein the learning algorithm comprises a switching learning algorithm.

10. The method recited in claim 1, comprising deriving local parameters for each of the plurality of wells by interpreting data related to the self responses.

11. The method recited in claim 1, wherein the data representing properties of each of the plurality of wells comprises one or more of the following: bottomhole pressure, surface pressure, production rate, injection rate, and/or wellbore temperature.

12. The method recited in claim 1, comprising pre-processing the data representing properties of each of the plurality of wells using one or more of the following: de-noising, rapid scoping, and/or segmentation.

13. The method recited in claim 1, comprising displaying a visualization of the data representative of the communication relationships.

14. A computer system that is adapted to determine interwell communication in a hydrocarbon-producing field that has a plurality of wells, the computer system comprising:
a processor; and
a non-transitory, computer-readable storage medium that stores computer-readable instructions for execution by the processor, the computer-readable instructions comprising:
code that, when executed by the processor, is adapted to cause the processor to determine communication relationships for the plurality of wells using a multivariate dynamic joint analysis algorithm based on data representing properties of each of the plurality of wells, the multivariate dynamic joint analysis algorithm employing a self-response of each of the plurality of wells and an interwell response between combinations of the plurality of wells; and
code that, when executed by the processor, is adapted to cause the processor to provide data representative of the communication relationships.

15. The computer system recited in claim 14, wherein the self-response comprises a pressure-rate response.

16. The computer system recited in claim 14, comprising code that, when executed by the processor, is adapted to cause the processor to solve for the self-response of each of the plurality of wells and the interwell responses using a cost function.

17. The computer system recited in claim 14, wherein the data representative of the communication relationships comprises a superposition based on the self-response of each of the plurality of wells and the interwell response between combinations of the plurality of wells.

18. The computer system recited in claim 14, comprising code that, when executed by the processor, is adapted to cause the processor to calculate a model system response based on the self-response of each of the plurality of wells and the interwell response between combinations of the plurality of wells.

19. The computer system recited in claim 14, comprising code that, when executed by the processor, is adapted to cause the processor to display a visualization of the data representative of the communication relationships.

20. A method for producing hydrocarbons using a determination of interwell communication in an oil and/or gas field that has a plurality of wells, the method comprising:
determining communication relationships for a plurality of wells in the oil and/or gas field using a multivariate dynamic joint analysis algorithm based on data representing properties of each of the plurality of wells, the multivariate dynamic joint analysis algorithm employing a self-response of each of the plurality of wells and an interwell response between combinations of the plurality of wells;
providing data representative of the communication relationships; and
extracting hydrocarbons from the oil and/or gas field based on the data representative of the communication relationships.

21. The method recited in claim 19, comprising displaying a visualization of the data representative of the communication relationships.
